(19) United States
(12) Patent Application Publication
(10) Pub. No.: US 2025/0336590 A1
(43) Pub. Date: Oct. 30, 2025

(54) INDUCTOR COMPONENT

(71) Applicant: Murata Manufacturing Co., Ltd., Kyoto-fu (JP)

(72) Inventors: Yoshimasa YOSHIOKA, Nagaokakyo-shi (JP); Yuuki KAWAKAMI, Nagaokakyo-shi (JP); Keisuke KUNIMORI, Nagaokakyo-shi (JP); Kenji TOYOSHIMA, Nagaokakyo-shi (JP)

(73) Assignee: Murata Manufacturing Co., Ltd., Kyoto-fu (JP)

(21) Appl. No.: 19/187,059

(22) Filed: Apr. 23, 2025

(30) Foreign Application Priority Data
Apr. 25, 2024 (JP) 2024-071765

(51) Int. Cl. H01F 27/28; H01F 27/29

(52) U.S. Cl. CPC H01F 27/2804; H01F 27/292; H01F 2027/2809

(57) ABSTRACT

An inductor component includes a first conductor layer that is on a first virtual plane, a second conductor layer that is on a second virtual plane, a first inductor wiring that is on the first conductor layer, that is between the first and second conductor layers in a first direction, and that extends around a first turning axis along the first direction, and a second inductor wiring that is on the second conductor layer in which the second conductor layer is between the first and second inductor wirings in the first direction, and that extends around a second turning axis along the first direction. The first conductor layer includes a first main body portion that extends around the first turning axis, and a first protruding portion that extends from the first main body portion in a direction separated from the first turning axis along a second direction.

### CROSS-REFERENCE TO RELATED APPLICATION

This application claims benefit of priority to Japanese Patent Application No. 2024-071765, filed Apr. 25, 2024, the entire content of which is incorporated herein by reference.

### BACKGROUND

### Technical Field

The present disclosure relates to an inductor component.

### Background Art

Japanese Patent No. 6922871 discloses an inductor component including a spiral wiring. In the inductor component of Japanese Patent No. 6922871, the spiral wiring is disposed between a first magnetic layer and a second magnetic layer laminated along a first direction.

### SUMMARY

In a case in which a plurality of the inductor components of Japanese Patent No. 6922871 are laminated in the first direction, there is room for improvement in the inductor component of Japanese Patent No. 6922871 in terms of increasing the short-circuit resistance between the spiral wirings of the inductor components adjacent to each other in the first direction.

Accordingly, the present disclosure provides an inductor component capable of increasing the short-circuit resistance between a first inductor wiring located on a first virtual plane and a second inductor wiring located on a second virtual plane parallel and adjacent to the first virtual plane.

An aspect of the present disclosure provides an inductor component including a first conductor layer that is located on a first virtual plane; a second conductor layer that is located on a second virtual plane parallel and adjacent to the first virtual plane; a first inductor wiring that is provided on the first conductor layer, that is located between the first conductor layer and the second conductor layer in a first direction intersecting with the first virtual plane and the second virtual plane, and that extends around a first turning axis along the first direction; and a second inductor wiring that is provided on the second conductor layer in which the second conductor layer is located between the first inductor wiring and the second inductor wiring in the first direction, and that extends around a second turning axis along the first direction. The first conductor layer includes a first main body portion that extends around the first turning axis, and a first protruding portion that extends from the first main body portion in a direction separated from the first turning axis along a second direction intersecting with the first direction. The second conductor layer includes a second main body portion that extends around the second turning axis, and a second protruding portion that extends from the second main body portion in a direction separated from the second turning axis along a third direction intersecting with the first direction and that is located at a position not overlapping with the first protruding portion when viewed along the first direction.

With the inductor component of the above-described aspect, it is possible to increase the short-circuit resistance between a first inductor wiring located on a first virtual plane and a second inductor wiring located on a second virtual plane parallel and adjacent to the first virtual plane.

### BRIEF DESCRIPTION OF THE DRAWINGS

FIG. 1 is a plan view illustrating an inductor component according to an aspect of the present disclosure;

FIG. 2 is a cross-sectional view taken along a line II-II of FIG. 1;

FIG. 3 is a schematic plan view illustrating layers of a first inductor wiring and a third inductor wiring of the inductor component of FIG. 1;

FIG. 4 is a schematic plan view illustrating layers of a second inductor wiring and a fourth inductor wiring of the inductor component of FIG. 1;

FIG. 5 is a first view illustrating an example of a manufacturing method for the inductor component of FIG. 1;

FIG. 6 is a second view illustrating the example of the manufacturing method for the inductor component of FIG. 1;

FIG. 7 is a third view illustrating the example of the manufacturing method for the inductor component of FIG. 1;

FIG. 8 is a fourth view illustrating the example of the manufacturing method for the inductor component of FIG. 1;

FIG. 9 is a fifth view illustrating the example of the manufacturing method for the inductor component of FIG. 1;

FIG. 10 is a sixth view illustrating the example of the manufacturing method for the inductor component of FIG. 1;

FIG. 11 is a seventh view illustrating the example of the manufacturing method for the inductor component of FIG. 1;

FIG. 12 is an eighth view illustrating the example of the manufacturing method for the inductor component of FIG. 1;

FIG. 13 is a ninth view illustrating the example of the manufacturing method for the inductor component of FIG. 1;

FIG. 14 is a tenth view illustrating the example of the manufacturing method for the inductor component of FIG. 1;

FIG. 15 is a first schematic plan view illustrating a first modification example of the inductor component of FIG. 1;

FIG. 16 is a second schematic plan view illustrating the first modification example of the inductor component of FIG. 1;

FIG. 17 is an enlarged side view illustrating a second modification example of the inductor component of FIG. 1; and

FIG. 18 is a perspective view illustrating a third modification example of the inductor component of FIG. 1.

### DETAILED DESCRIPTION

Various aspects of the present disclosure will be described.

A first aspect provides an aspect of the present disclosure provides an inductor component including: a first conductor layer that is located on a first virtual plane; a second conductor layer that is located on a second virtual plane parallel and adjacent to the first virtual plane; a first inductor wiring that is provided on the first conductor layer, that is located between the first conductor layer and the second conductor layer in a first direction intersecting with the first virtual plane and the second virtual plane, and that extends around a first turning axis along the first direction; and a second inductor wiring that is provided on the second conductor layer in which the second conductor layer is located between the first inductor wiring and the second inductor wiring in the first direction, and that extends around a second turning axis along the first direction. The first conductor layer includes a first main body portion that extends around the first turning axis, and a first protruding portion that extends from the first main body portion in a direction separated from the first turning axis along a second direction intersecting with the first direction. The second conductor layer includes a second main body portion that extends around the second turning axis, and a second protruding portion that extends from the second main body portion in a direction separated from the second turning axis along a third direction intersecting with the first direction and that is located at a position not overlapping with the first protruding portion when viewed along the first direction.

A second aspect provides the inductor component according to the first aspect, in which in a case in which, when viewed along the first direction, a virtual straight line connecting the first turning axis and a center of the first protruding portion in a direction intersecting with the second direction to each other is defined as a first virtual straight line, and a virtual straight line connecting the second turning axis and a center of the second protruding portion in a direction intersecting with the third direction to each other is defined as a second virtual straight line, the first virtual straight line and the second virtual straight line form an angle of 80 degrees to 110 degrees.

A third aspect provides the inductor component according to the first or second aspect, further including: an element body in which the first conductor layer, the second conductor layer, the first inductor wiring, and the second inductor wiring are located; a first insulating layer that is provided on the first conductor layer and that is located on a side opposite to the first inductor wiring with respect to the first conductor layer in the first direction; and a second insulating layer that is provided on the second conductor layer and that is located on a side opposite to the second inductor wiring with respect to the second conductor layer in the first direction. The first protruding portion is located closer to the first turning axis than an end portion of the first insulating layer in the second direction when viewed along the first direction, and the second protruding portion is located closer to the second turning axis than an end portion of the second insulating layer in the third direction when viewed along the first direction.

A fourth aspect provides the inductor component according to the third aspect, in which the element body has a side surface intersecting with the second direction, and the second conductor layer includes a plurality of protruding portions that are provided in a portion facing the side surface.

A fifth aspect provides the inductor component according to any one of the first to fourth aspects, in which the first conductor layer has a thickness that is a dimension in the first direction of smaller than 1.0 μm, and the thickness of the first conductor layer is smaller than 1/100 of the thickness of the first inductor wiring.

A sixth aspect provides the inductor component according to any one of the first to fifth aspects, in which each of the first conductor layer and the second conductor layer includes a plurality of layers that are laminated along the first direction.

A seventh aspect provides the inductor component according to any one of the first to sixth aspects, further including: a third insulating layer that extends from the first protruding portion toward the second virtual plane along the first direction and that has a thickness that is a dimension in the first direction, the thickness being larger than the thickness of the first inductor wiring.

An eighth aspect provides the inductor component according to the first to seventh aspects, further including: an element body that includes a magnetic material and in which the first inductor wiring and the second inductor wiring are located; an external terminal that is provided on an outer surface of the element body intersecting with the first direction; and a vertical wiring and a fourth insulating layer that are located inside the element body. The second inductor wiring, among all inductor wirings including the first inductor wiring and the second inductor wiring, is located closest to the external terminal in the first direction, the vertical wiring extends in the first direction and connects the second inductor wiring and the external terminal to each other in a state of being in contact with the magnetic material of the element body in the second direction, and the fourth insulating layer is located between the second inductor wiring and the magnetic material of the element body.

A ninth aspect provides the inductor component according to any one of the first to eighth aspects, further including an element body that includes a magnetic material and in which the first conductor layer, the second conductor layer, the first inductor wiring, and the second inductor wiring are located, in which a distal end portion, which is farther from the first main body portion, among both ends of the first protruding portion in the second direction is in contact with the magnetic material.

A tenth aspect provides the inductor component according to any one of the first to ninth aspects, further including an element body in which the first conductor layer, the second conductor layer, the first inductor wiring, and the second inductor wiring are located, in which the element body has a side surface intersecting with the second direction, and a distal end portion, which is farther from the first main body portion, among both ends of the first protruding portion in the second direction is exposed from the side surface and is in contact with at least one insulating layer.

An eleventh aspect provides the inductor component according to the tenth aspect, in which the distal end portion is in contact with a plurality of insulating layers.

A twelfth aspect provides the inductor component according to any one of the first to eleventh aspects, further including: a rectangular parallelepiped-shaped element body in which the first conductor layer, the second conductor layer, the first inductor wiring, and the second inductor wiring are located; and an external terminal that is provided on an outer surface of the element body intersecting with the first direction. The second inductor wiring, among all inductor wirings including the first inductor wiring and the second inductor wiring, is located closest to the external terminal in the first direction, the element body has a side surface intersecting with the third direction, the side surface intersecting with the third direction includes a side surface extending in a longitudinal direction of the element body, and a distal end portion, which is farther from the second main body portion, among both ends of the second protruding portion in the third direction is exposed only from the side surface extending in the longitudinal direction.

A thirteenth aspect provides the inductor component according to any one of the first to twelfth aspects, further including: an element body that includes a magnetic material and in which the first conductor layer, the second conductor layer, the first inductor wiring, and the second inductor wiring are located; a fourth protruding portion that is located inside the element body and that extends from the first main body portion in a direction approaching the first turning axis along the second direction; and a fifth protruding portion that is located inside the element body and that extends from the second main body portion in a direction approaching the second turning axis along the third direction. An end portion, which is closer to the first turning axis, among both ends of the fourth protruding portion in the second direction is in contact with the magnetic material of the element body, and an end portion, which is closer to the second turning axis, among both ends of the fifth protruding portion in the third direction is in contact with the magnetic material of the element body.

A fourteenth aspect provides the inductor component according to the thirteenth aspect, in which the inductor component includes a plurality of the fourth protruding portions and a plurality of the fifth protruding portions, the number of the fourth protruding portions is equal to or larger than the number of the first protruding portions, and the number of the fifth protruding portions is equal to or larger than the number of the second protruding portions.

A fifteenth aspect provides the inductor component according to any one of the first to fourteenth aspects, further including: a third conductor layer that is located on the first virtual plane and that is electrically independent of the first conductor layer; a third inductor wiring that is provided on the third conductor layer, that is located between the third conductor layer and the second conductor layer in the first direction, that extends in the first direction, and that extends around a third turning axis located away from the first turning axis; and a third protruding portion that extends from the third conductor layer in a direction separated from the third turning axis along the second direction. The first protruding portion and the third protruding portion are located on the same virtual straight line.

Hereinafter, embodiments of the present disclosure will be described with reference to the drawings. The following description is not intended to limit the present disclosure, is merely an example, and can be appropriately changed without departing from the gist of the present disclosure. The drawings are schematic, and the ratios of the respective dimensions and the like do not necessarily match the actual values. In the following description, the terms “about”, “approximately”, “substantially”, and the like mean that the values, the shapes, and the like following these terms include a range of allowable errors decided on by those skilled in the art.

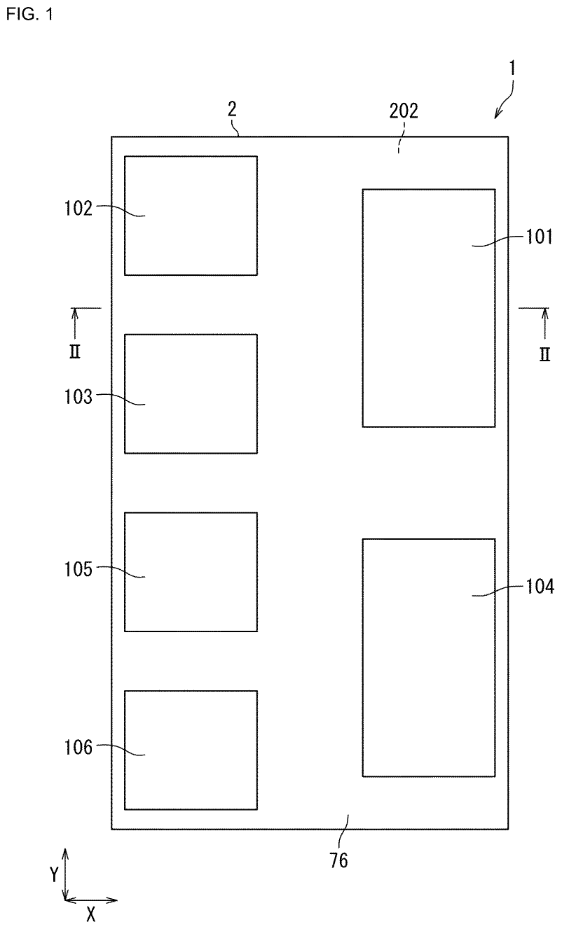

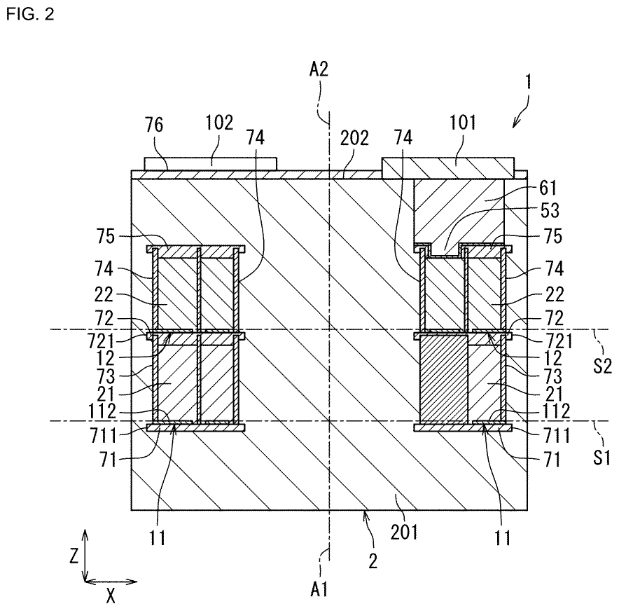

As illustrated in FIGS. 1 and 2, an inductor component 1 of the present disclosure includes a first conductor layer 11, a first inductor wiring 21, a second conductor layer 12, and a second inductor wiring 22.

As illustrated in FIG. 2, the first conductor layer 11 is located on a first virtual plane S1, and the second conductor layer 12 is located on a second virtual plane S2 parallel and adjacent to the first virtual plane S1. Here, the second virtual plane S2 parallel and adjacent to the first virtual plane S1 means that the first virtual plane S1 and the second virtual plane S2 are parallel to each other, and the second virtual plane is present at a position separated in a direction orthogonal to the first virtual plane S1. The first inductor wiring 21 is provided on the first conductor layer 11 and extends along the first virtual plane S1. The one inductor wiring 21 is located between the first conductor layer 11 and the second conductor layer 12 in a first direction (for example, a Z direction) intersecting with the first virtual plane S1 and the second virtual plane S2, and extends (is located) around a first turning axis A1 that intersects with (for example, is orthogonal to) the first virtual plane S1. As an example, the first virtual plane S1 is located at a boundary between the first conductor layer 11 and the first inductor wiring 21. The second inductor wiring 22 is provided on the second conductor layer 12 and extends along the second virtual plane S2. The second inductor wiring 22 is located on a side opposite to the first inductor wiring 21 with respect to the second conductor layer 12 in the first direction Z and extends (is located) around a second turning axis A2 that intersects with (for example, is orthogonal to) the second virtual plane S2. As an example, the second virtual plane S2 is located at a boundary between the second conductor layer 12 and the second inductor wiring 22.

In the present aspect, as illustrated in FIGS. 1 to 4, the inductor component 1 includes a substantially rectangular parallelepiped-shaped element body 2, a third conductor layer 13, a fourth conductor layer 14, a third inductor wiring 23 that is provided on the third conductor layer 13, and a fourth inductor wiring 24 that is provided on the fourth conductor layer 14. The element body 2 has, for example, a size of 1.2×2.1×0.55 mm. The third conductor layer 13 is located on the first virtual plane S1 and is electrically independent of the first conductor layer 11. The fourth conductor layer 14 is located on the second virtual plane S2 and is electrically independent of the second conductor layer 12. The third inductor wiring 23 extends along the first virtual plane S1. The fourth inductor wiring 24 extends along the second virtual plane S2. The layers of the first inductor wiring 21 and the third inductor wiring 23 are located between the first virtual plane S1 and the second virtual plane S2, and the layers of the second inductor wiring 22 and the fourth inductor wiring 24 are located between the second virtual plane S2 and a main surface 202 of the element body 2 described later.

The element body 2 includes a magnetic material (magnetic layer) 201, and the first conductor layer 11, the second conductor layer 12, the third conductor layer 13, the fourth conductor layer 14, the first inductor wiring 21, the second inductor wiring 22, the third inductor wiring 23, and the fourth inductor wiring 24 are located inside the element body 2. As illustrated in FIG. 2, the element body 2 has an outer surface (hereinafter, referred to as the main surface 202) intersecting with the first direction Z. As illustrated in FIG. 1, a plurality of external terminals (six external terminals 101 to 106 in the present aspect) and an insulating layer 76 are provided on the main surface 202. The insulating layer 76 has, for example, a thickness of 10 μm. In the present aspect, the second inductor wiring 22, among all the inductor wirings including the first inductor wiring 21 and the second inductor wiring 22, is located closest to the main surface 202 (that is, the external terminal 101) in the first direction Z. Each of the external terminals 101 to 106 is formed of, for example, a multilayer body of Cu/Ni/Au (=5/5/0.1 um).

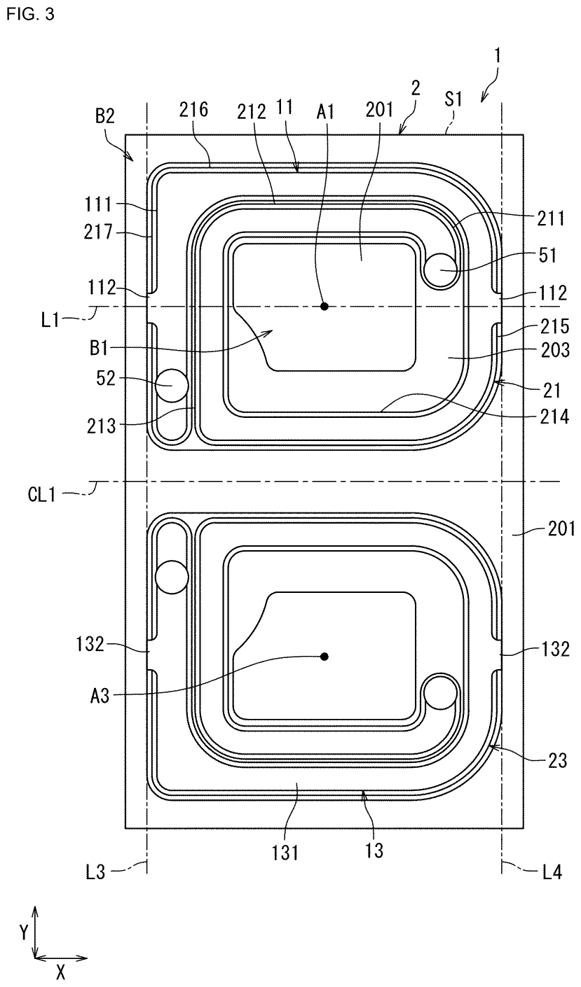

As illustrated in FIG. 3, when viewed along the first direction Z, the third conductor layer 13 is located symmetrically with respect to the first conductor layer 11 with a first center line CL1, which extends on the first virtual plane S1 in a lateral direction (for example, an X direction) of the inductor component 1, interposed therebetween, and has a shape symmetrical with respect to the first conductor layer 11 with the first center line CL1 interposed therebetween. The third inductor wiring 23 is located symmetrically with respect to the first inductor wiring 21 with the first center line CL1 interposed therebetween, and has a shape symmetrical with respect to the first inductor wiring 21 with the first center line CL1 interposed therebetween. The third inductor wiring 23 is located around a third turning axis A3 that is located symmetrically with respect to the first turning axis A1 with the first center line CL1 interposed therebetween.

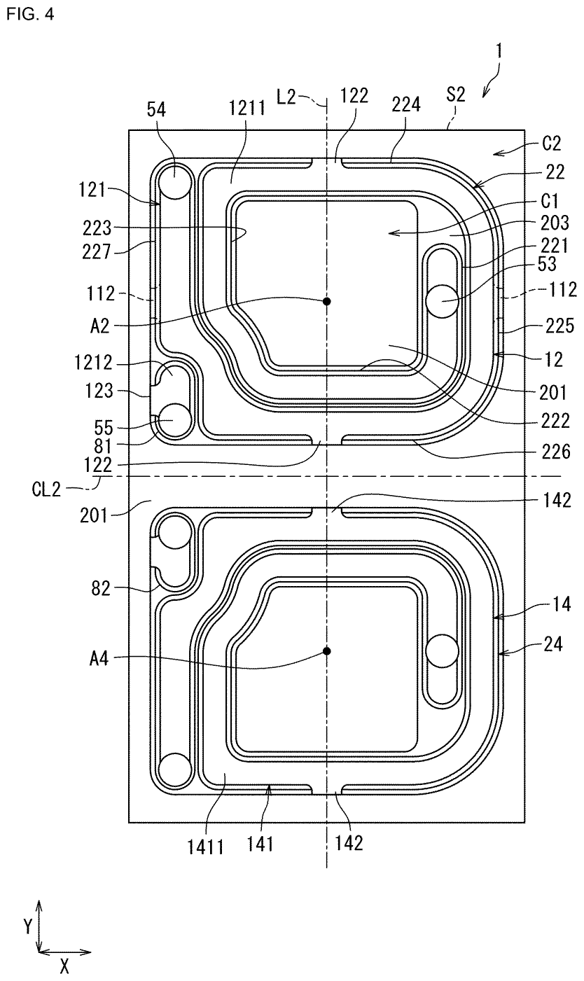

As illustrated in FIG. 4, when viewed along the first direction Z, the fourth conductor layer 14 is located symmetrically with respect to the second conductor layer 12 with a second center line CL2, which extends in the lateral direction X on the second virtual plane S2, interposed therebetween, and has a shape symmetrical with respect to the second conductor layer 12 with the second center line CL2 interposed therebetween. The fourth inductor wiring 24 is located symmetrically with respect to the second inductor wiring 22 with the second center line CL2 interposed therebetween, and has a shape symmetrical with respect to the second inductor wiring 22 with the second center line CL2 interposed therebetween. The fourth inductor wiring 24 is located around a fourth turning axis A4 that is located symmetrically with respect to the second turning axis A2 with the second center line CL2 interposed therebetween.

As an example, the first turning axis A1 and the second turning axis A2 are located on the same straight line (see FIG. 2), and the third turning axis A3 and the fourth turning axis A4 are located on the same straight line. The first center line CL1 and the second center line CL2 are located substantially at the center in a longitudinal direction (for example, a Y direction) of the inductor component 1 when viewed along the first direction Z.

As illustrated in FIG. 3, the first inductor wiring 21 has a spiral shape as an example when viewed along the first direction Z. As an example, the first turning axis A1 is located at the center with respect to an outer shape of the first inductor wiring 21. Vias 51 and 52 are connected to both ends of the first inductor wiring 21 in a direction in which the first inductor wiring 21 extends. The first inductor wiring 21 is formed of, for example, a multilayer body of L/S/t (=100/10/150 μm).

The first inductor wiring 21 includes a first portion 211 to a seventh portion 217.

The first portion 211 extends from an end portion located close to the first turning axis A1 to which the via 51 is connected, in a direction separated from the first center line CL1 along the longitudinal direction Y. As an example, a portion of the first portion 211 to which the via 51 is connected forms a first output portion.

The second portion 212 extends X from an end portion, which is farther from the first center line CL1, among both ends of the first portion 211 in the longitudinal direction Y, along the lateral direction.

The third portion 213 extends from an end portion, which is farther from the first portion 211, among both ends of the second portion 212 in the lateral direction X in a direction approaching the first center line CL1 along the longitudinal direction Y.

The fourth portion 214 extends from an end portion, which is farther from the second portion 212, among both ends of the third portion 213 in the longitudinal direction Y, in a direction approaching the first portion 211 along the lateral direction Y.

The fifth portion 215 extends from an end portion, which is farther from the third portion 213, among both ends of the fourth portion 214 in the lateral direction X in a direction separated from the first center line CL1 along the longitudinal direction Y. The fifth portion 215 is located at a position farther from the first portion 211 than the first turning axis A1 in the lateral direction X, and a part of the fifth portion 215 overlaps with the first portion 211 when viewed from the first turning axis A1 along the lateral direction X. The fifth portion 215 and the first portion 211 are insulated from each other.

The sixth portion 216 extends from an end portion, which is farther from the fourth portion 214, among both ends of the fifth portion 215 in the longitudinal direction Y, in a direction approaching the third portion 213 along the lateral direction X. The sixth portion 216 is located at a position farther from the first turning axis A1 than the second portion 212 in the longitudinal direction Y, and a part of the sixth portion 216 overlaps with the second portion 212 when viewed from the first turning axis A1 along the longitudinal direction Y. The sixth portion 216 and the second portion 212 are insulated from each other.

The seventh portion 217 extends from an end portion, which is farther from the fifth portion 215, among both ends of the sixth portion 216 in the lateral direction X in a direction approaching the first center line CL1 along the longitudinal direction Y. The seventh portion 217 is located at a position farther from the first turning axis A1 than the third portion 213 in the lateral direction X, and a part of the seventh portion 217 overlaps with the third portion 213 when viewed from the first turning axis A1 along the lateral direction X. The seventh portion 217 and the third portion 213 are insulated from each other. The via 52 is connected to an end portion, which is closer to the first center line CL1, among both ends of the seventh portion 217 in the longitudinal direction Y. As an example, a portion of the seventh portion 217 to which the via 52 is connected forms a first input portion. As illustrated in FIG. 3, the first conductor layer 11 includes a first main body portion 111 that extends (is located) around the first turning axis A1 and a protruding portion 112 (an example of a first protruding portion) that is provided on the first main body portion 111. In the present aspect, when viewed along the first direction Z, the first main body portion 111 has substantially the same shape as the first inductor wiring 21, and the entire first main body portion 111 overlaps with the first inductor wiring 21. The protruding portion 112 extends from the first main body portion 111 in a direction separated from the first turning axis A1 along a second direction (for example, the lateral direction X) intersecting with the first direction Z. The first main body portion 111 and the protruding portion 112 may be formed of the same member or may be formed of different members.

In the present aspect, the first conductor layer 11 includes two protruding portions 112 extending along the second direction X. As an example, the two protruding portions 112 are located symmetrically with respect to each other with the first turning axis A1 interposed therebetween. Each protruding portion 112 is provided in a portion of the first main body portion 111 corresponding to the fifth portion 215 (in other words, a portion of the first main body portion 111 overlapping with the fifth portion 215 when viewed along the first direction Z) and a portion of the first main body portion 111 corresponding to the seventh portion 217 (in other words, a portion of the first main body portion 111 overlapping with the seventh portion 217 when viewed along the first direction Z). A distal end portion, which is farther from the first main body portion 111, among both ends of each protruding portion 112 in the second direction X is in contact with the magnetic material 201 of the element body 2.

The phrase “in contact with the magnetic material 201” means being in contact with a part of a material forming the magnetic material 201. In a case in which the magnetic material 201 is formed of, for example, a composite body of a resin and an inorganic filler (for example, a composite body of epoxy and FeSiCr), a distal end portion of the protruding portion 112 is in contact with at least one of the resin and the inorganic filler of the magnetic material 201. The resin contained in the magnetic material 201 includes, for example, epoxy, acryl, a liquid crystal polymer, phenol, and a combination thereof, and is responsible for the strength of the element body 2 and a good insulating property. The inorganic filler contained in the magnetic material 201 includes, for example, a metal magnetic powder (for example, a powder containing, as a main component, an Fe element such as an Fe, FeSi-based, FeSiCr-based, or FeNi-based powder). The magnetic material 201 in this case has a high magnetic permeability and a high magnetism saturation density. The inorganic filler does not need to be a single type of magnetic powder, and may be a magnetic powder in which different compositions and different particle diameters are combined, or may contain an insulating filler such as silica to ensure a coefficient of linear expansion and the insulating property.

As illustrated in FIG. 3, the element body 2 has, inside, the first region B1 closer to the first turning axis A1 than the first inductor wiring 21 and a second region B2 farther from the first turning axis A1 than the first inductor wiring 21. In the present aspect, the first region B1 is surrounded by the first portion 211 to the fourth portion 214 and a part of the fifth portion 215 of the first inductor wiring 21 when viewed along the first direction Z. The magnetic material 201 and a non-magnetic material 203 are located in the first region B1. When viewed along the first direction Z, the magnetic material 201 of the first region B1 has a substantially rectangular shape and is adjacent to a portion (in the present aspect, the first portion 211 to the third portion 213) with which the first inductor wiring 21 overlaps when viewed from the first turning axis A1 along a direction intersecting with the first direction. In other words, the magnetic material 201 is adjacent to a portion including the largest number of the first inductor wirings 21 when viewed from the first turning axis A1 along a direction intersecting with the first direction. The non-magnetic material 203 of the first region B1 is provided between a portion (in the present aspect, the fourth portion 214 and the fifth portion 215) with which the first inductor wiring 21 does not overlap and the magnetic material 201 of the first region B1 when viewed from the first turning axis A1 along the second direction. The non-magnetic material 203 extends along the third portion 213, the fourth portion 214, and the fifth portion 215 when viewed along the first direction Z. The magnetic material 201 is located over the entire second region B2.

As illustrated in FIG. 4, the second inductor wiring 22 is located around the second turning axis A2 along the first direction Z. In the present aspect, the second inductor wiring 22 has a spiral shape that is wound in a direction opposite to the first inductor wiring 21 when viewed along the first direction Z. As an example, the second turning axis A2 is located at the center with respect to the outer shape of the second inductor wiring 22. The second inductor wiring 22 is formed of, for example, a multilayer body of L/S/t (=100/10/150 μm). Vias 53 and 54 extending in the first direction Z are connected to both ends of the second inductor wiring 22 in a direction in which the second inductor wiring 22 extends. As illustrated in FIG. 2, the via 53 connects the second inductor wiring 22 and a vertical wiring 61 to each other. The vertical wiring 61 connects the second inductor wiring 22 and the external terminal 101 to each other through the via 53. An insulating layer 75 is located between the second inductor wiring 22 and the vertical wiring 61 in the first direction Z. The insulating layer 75 has, for example, a thickness of 15 μm.

The second inductor wiring 22 has a first portion 221 to a seventh portion 227.

The first portion 221 extends from an end portion located close to the first turning axis A1 to which the via 53 is connected, in a direction approaching the second center line CL2 along the longitudinal direction Y. As an example, a portion of the first portion 221 to which the via 53 is connected forms a second output portion. The vias 51 and 53 are adjacent to each other when viewed along the first direction Z. The via 51 connects a portion of the first inductor wiring 21 to which the via 51 is connected and a portion of the second inductor wiring 22 to which the via 53 is connected, to each other. That is, the first output portion and the second output portion are adjacent to each other. The phrase “the first output portion and the second output portion are adjacent to each other” means, for example, a state in which the vias 51 and 53 are located in a very narrow region (for example, within 20 μm) when viewed along the first direction Z. In the present aspect, the vias 51 and 53 are located at a distance of about 10 μm when viewed along the first direction Z.

The second portion 222 extends from an end portion, which is closer to the second center line CL2, among both ends of the first portion 221 in the longitudinal direction Y, along the lateral direction X.

The third portion 223 extends from an end portion, which is farther from the first portion 221, among both ends of the second portion 222 in the lateral direction X, in a direction separated from the second center line CL2 along the longitudinal direction Y.

The fourth portion 224 extends from an end portion, which is farther from the second portion 222, among both ends of the third portion 223 in the longitudinal direction Y, in a direction approaching the first portion 221 along the lateral direction Y.

The fifth portion 225 extends from an end portion, which is farther from the third portion 223, among both ends of the fourth portion 224 in the lateral direction X, in a direction approaching the second center line CL2 along the longitudinal direction Y. The fifth portion 225 is located at a position farther from the second turning axis A2 than the first portion 221 in the lateral direction X, and a part of the fifth portion 225 overlaps with the first portion 221 when viewed from the second turning axis A2 along the lateral direction X. The fifth portion 225 and the first portion 221 are insulated from each other.

The sixth portion 226 extends from an end portion, which is farther from the fourth portion 224, among both ends of the fifth portion 225 in the longitudinal direction Y, in a direction approaching the third portion 223 along the lateral direction X. The sixth portion 226 is located at a position farther from the second portion 222 than the second turning axis A2 in the longitudinal direction Y, and a part of the sixth portion 226 overlaps with the second portion 222 when viewed from the second turning axis A2 along the longitudinal direction Y. The sixth portion 226 and the second portion 222 are insulated from each other.

The seventh portion 227 extends from an end portion, which is farther from the fifth portion 225, among both ends of the sixth portion 226 in the lateral direction X, in a direction separated from the second center line CL2 along the longitudinal direction Y. The seventh portion 227 is located at a position farther from the second turning axis A2 than the third portion 223 in the lateral direction X, and a part of the seventh portion 227 overlaps with the third portion 223 when viewed from the second turning axis A2 along the lateral direction X. The seventh portion 227 and the third portion 223 are insulated from each other. The via 54 is connected to an end portion, which is farther from the second center line CL2, among both ends of the seventh portion 227 in the longitudinal direction Y. As an example, a portion of the seventh portion 227 to which the via 54 are connected forms a second input portion. As illustrated in FIGS. 3 and 4, the vias 52 and 54 are located with spacing from each other in the longitudinal direction Y when viewed along the first direction Z. That is, the first input portion and the second input portion are located at positions separated from each other in the longitudinal direction Y. Since the vias 52 and 54 are located at positions separated from each other by a distance of 200 μm or more (for example, 500 μm) when viewed along the first direction Z, the first input portion and the second input portion can be separated from each other.

As illustrated in FIG. 4, the second conductor layer 12 includes a second main body portion 121 that extends (is located) around the second turning axis A2, and a protruding portion 122 (an example of a second protruding portion) that is provided on the second main body portion 121. When viewed along the first direction Z, the second main body portion 121 has a turning portion 1211 that has substantially the same shape as the second inductor wiring 22 and a non-turning portion 1212 that is adjacent to the turning portion 1211 in an electrically independent state. In the present aspect, the entire turning portion 1211 overlaps with the second inductor wiring 22 when viewed along the first direction Z. When viewed along the first direction Z, the non-turning portion 1212 has an elongated circular shape that extends along the longitudinal direction Y and is adjacent to a portion in which the sixth portion 226 and the seventh portion 227 of the second inductor wiring 22 are connected to each other. The turning portion 1211 and the protruding portion 122 of the second main body portion 121 may be formed of the same member or may be formed of different members.

A protruding portion 123 is provided at the center of the non-turning portion 1212 in the longitudinal direction Y. The protruding portion 123 extends from the non-turning portion 1212 in a direction separated from the second turning axis A2 in the lateral direction X. A distal end portion, which is farther from the non-turning portion 1212, among both ends of the protruding portion 123 in the lateral direction X is in contact with the magnetic material 201 of the element body 2. The non-turning portion 1212 and the protruding portion 123 of the second main body portion 121 may be formed of the same member or may be formed of different members.

As illustrated in FIG. 4, in the present aspect, the second conductor layer 12 includes two protruding portions 122 that extend from the second main body portion 121 (in the present aspect, the turning portion 1211) along a third direction (for example, the longitudinal direction Y). As an example, the two protruding portions 122 are located symmetrically with respect to each other with the second turning axis A2 interposed therebetween. Each protruding portion 122 is provided in a portion of the second main body portion 121 corresponding to the fourth portion 224 (in other words, a portion of the second main body portion 121 overlapping with the fourth portion 224 when viewed along the first direction Z) and a portion of the second main body portion 121 corresponding to the sixth portion 226 (in other words, a portion of the second main body portion 121 overlapping with the sixth portion 226 when viewed along the first direction Z). That is, the protruding portion 122 is located at a position not overlapping with the protruding portion 112 when viewed along the first direction Z. A distal end portion, which is farther from the second main body portion 121, among both ends of each protruding portion 122 in the third direction Y is in contact with the magnetic material 201 of the element body 2.

As illustrated in FIG. 4, the element body 2 has, inside, the first region C1 closer to the second turning axis A2 than the second inductor wiring 22 and a second region C2 farther from the second turning axis A2 than the second inductor wiring 22. In the present aspect, the first region C1 is surrounded by the first portion 221 to the fifth portion 225 of the second inductor wiring 22 when viewed along the first direction Z. The magnetic material 201 and the non-magnetic material 203 are located in the first region C1. When viewed along the first direction Z, the magnetic material 201 of the first region C1 has a substantially rectangular shape and is adjacent to the first portion 211 to the fourth portion 224. In other words, the magnetic material 201 is located close to a portion including the largest number of the second inductor wirings 22 when viewed from the second turning axis A2 along the second direction. When viewed along the first direction Z, the non-magnetic material 203 of the first region C1 is adjacent to the magnetic material 201 of the first region C1, the first portion 221, the fourth portion 224, and the fifth portion 225. The magnetic material 201 is located over the entire second region C2.

As illustrated in FIG. 3, a virtual straight line connecting the first turning axis A1 and the center of the protruding portion 112 in a direction (for example, the longitudinal direction Y) intersecting with the second direction to each other is defined as a first virtual straight line L1. As illustrated in FIG. 4, a virtual straight line connecting the second turning axis A2 and the center of the protruding portion 122 in a direction (for example, the lateral direction X) intersecting with the third direction to each other is defined as a second virtual straight line L2. The inductor component 1 is formed such that the first virtual straight line L1 and the second virtual straight line L2 form an angle of 80 degrees to 110 degrees.

As illustrated in FIG. 4, the inductor component 1 includes a first pad portion 81 and a second pad portion 82 that are located on the second virtual plane S2. The first pad portion 81 is located to overlap with the non-turning portion 1212 of the second conductor layer 12 when viewed along the first direction Z. A via 55 is connected to an end portion, which is closer to the second center line CL2, among both ends of the first pad portion 81 in the longitudinal direction Y. The first pad portion 81 and the second pad portion 82 are located symmetrically with respect to each other with the second center line CL2 interposed therebetween, and have a shape symmetrical with respect to each other with the second center line CL2 interposed therebetween.

In the present aspect, as illustrated in FIG. 2, the inductor component 1 includes a first insulating layer 71 and a second insulating layer 72 that are located inside the element body 2. The first insulating layer 71 is provided on the first conductor layer 11 and is located on a side opposite to the first inductor wiring 21 with respect to the first conductor layer 11 in the first direction Z. The second insulating layer 72 is provided on the second conductor layer 12 and is located on a side opposite to the second inductor wiring 22 with respect to the second conductor layer 12 in the first direction Z. The protruding portion 112 is located closer to the first turning axis A1 than an end portion of the first insulating layer 71 in the second direction (for example, an end portion 711 in the lateral direction X illustrated in FIG. 2) when viewed along the first direction Z. The protruding portion 122 is located closer to the second turning axis A2 than an end portion of the second insulating layer 72 in the third direction X (for example, an end portion 721 in the lateral direction X illustrated in FIG. 2) when viewed along the first direction Z.

As an example, the first conductor layer 11 has a thickness that is a dimension in the first direction Z of smaller than 1.0 μm. The thickness of the first conductor layer 11 is smaller than 1/100 of the thickness of the first inductor wiring 21. The second conductor layer 12 may also be formed in the same manner as the first conductor layer 11. That is, the second conductor layer 12 may be formed to have a thickness of smaller than 1.0 μm and smaller than 1/100 of the thickness of the second inductor wiring 22.

As an example, the first conductor layer 11 and the second conductor layer 12 each include a single layer (Cu or Ag) or a plurality of layers (for example, Ti/Cu) laminated along the first direction Z.

In the present aspect, as illustrated in FIG. 2, the inductor component 1 includes a third insulating layer 73 that is located inside the element body 2. The third insulating layer 73 extends from the protruding portion 112 toward the second virtual plane S2 along the first direction Z. The dimension (=thickness) of the third insulating layer 73 in the first direction Z is larger than the thickness of the first inductor wiring 21. The inductor component 1 may include an insulating layer (not illustrated) that extends from the protruding portion 122 in a direction separated from the first virtual plane S1 along the first direction Z and that has a thickness larger than the thickness of the second inductor wiring 22.

As an example, as illustrated in FIG. 2, the inductor component 1 includes the external terminal 101 that is provided on the main surface 202, and a vertical wiring 61 and a fourth insulating layer 74 that are located inside the element body 2. The vertical wiring 61 extends in the first direction Z and connects the second inductor wiring 22 and the external terminal 101 to each other in a state of being in contact with the magnetic material 201 of the element body 2 in the second direction. The fourth insulating layer 74 is located between the second inductor wiring 22 and the magnetic material 201 of the element body 2.

As an example, as illustrated in FIG. 3, the protruding portion 112 of the first conductor layer 11 and the protruding portion 132 (an example of a third protruding portion) of the third conductor layer 13 are located on the same virtual straight lines L3 and L4. The protruding portion 132 extends from the third main body portion 131 in a direction separated from the third turning axis A3 along the lateral direction X. As illustrated in FIG. 4, the protruding portion 122 of the second conductor layer 12 and a protruding portion 142 of the fourth conductor layer 14 are located on the same virtual straight line L2. The protruding portion 142 extends from a turning portion 1411 of a fourth main plate portion 141 in a direction separated from the fourth turning axis A4 along the longitudinal direction Y.

The insulating layer (for example, the insulating layers 71, 72, and 75) in contact with both ends of the first inductor wiring 21 and the second inductor wiring 22 in the first direction Z and the insulating layer (for example, the insulating layers 73 and 74) in contact with both ends of the first inductor wiring 21 and the second inductor wiring 22 in the second direction are formed of, for example, different materials. As an example, the insulating layers 71, 72, and 75 are formed of an insulating material consisting of an epoxy material and an inorganic filler, and the insulating layers 73 and 74 are formed of an acrylic insulating material.

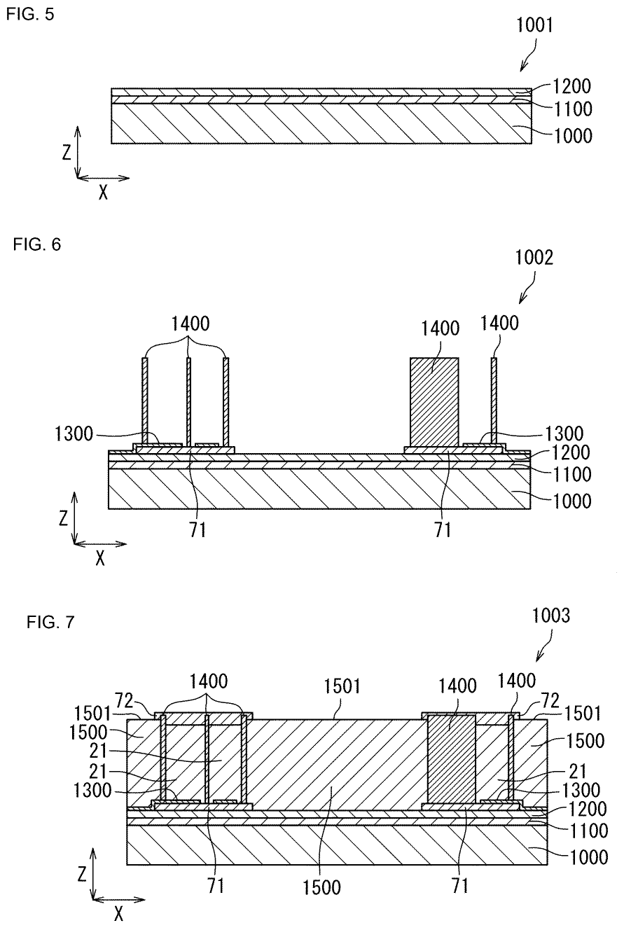

An example of a manufacturing method for the inductor component 1 will be described with reference to FIGS. 5 to 14. In the following description, the third conductor layer 13, the fourth conductor layer 14, the third inductor wiring 23, and the fourth inductor wiring 24 will not be described. FIGS. 5 to 14 are views corresponding to cross sections taken along a line II-II of FIG. 1. In the manufacturing method illustrated in FIGS. 5 to 14, for example, a part or all of the steps are automatically performed by using a manufacturing apparatus for the inductor component 1.

As illustrated in FIGS. 5 and 6, the manufacturing apparatus forms the first insulating layer 71 on a first multilayer body 1001 in which an adhesive layer 1100 and a seed layer (conductor) 1200 are laminated on a substrate 1000, and then forms a pattern seed 1300 extending over the first insulating layer 71 and the seed layer 1200 and a permanent resist 1400 to form a second multilayer body 1002. The pattern seed 1300 forms the first conductor layer 11. The first insulating layer 71 is formed by, for example, a step including lamination of insulating layers, photolithography (photolithography), and solidification. The pattern seed 1300 is formed by, for example, a step including sputtering (seed formation), resist lamination, photolithography, seed etching, and resist peeling. The permanent resist 1400 is formed by, for example, a step including permanent resist coating, photolithography, and solidification. A part of the permanent resist 1400 forms the non-magnetic material 203 and the third insulating layer 73.

As illustrated in FIG. 7, the manufacturing apparatus simultaneously forms the first inductor wiring 21 and sacrificial copper 1500 on the second multilayer body 1002, and then forms the second insulating layer 72 on the first inductor wiring 21. The first inductor wiring 21 and the sacrificial copper 1500 are formed by, for example, a step including electric field plating (for example, electric field copper plating). The second insulating layer 72 is formed by, for example, a step including insulating layer lamination, photolithography, and solidification. In this case, a magnetic path cavity 1501 and the vias 51 and 52 are simultaneously formed during the photolithography step.

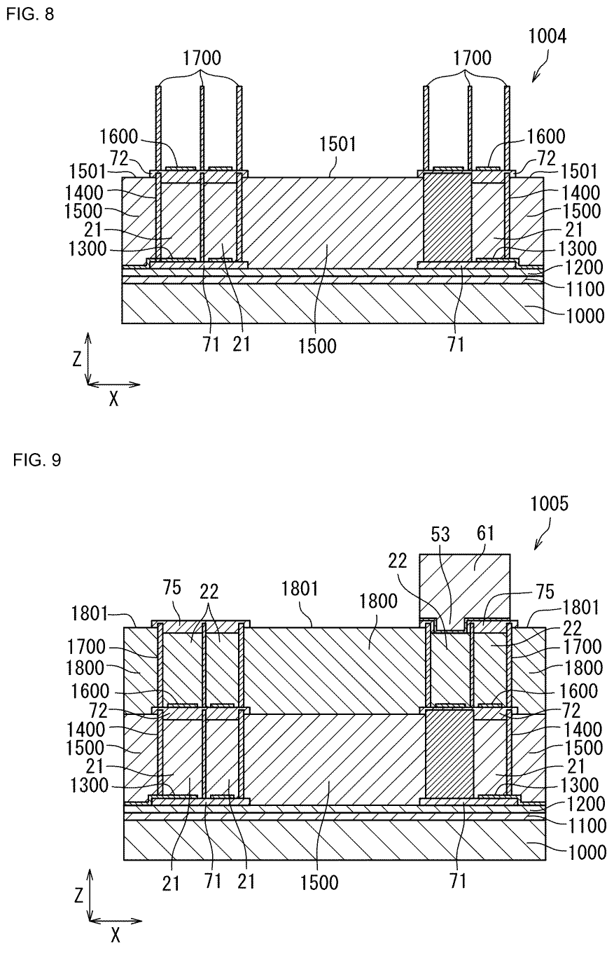

As illustrated in FIG. 8, the manufacturing apparatus forms a pattern seed 1600 and a permanent resist 1700 located at the second insulating layer 72 on a third multilayer body 1003 to form a fourth multilayer body 1004. The pattern seed 1600 forms the second conductor layer 12. The pattern seed 1600 is formed by, for example, a step including sputtering (seed formation), resist lamination, photolithography, seed etching, and resist peeling. The permanent resist 1700 is formed by a step including permanent resist lamination, photolithography, and solidification. A part of the permanent resist 1700 forms the fourth insulating layer 74.

The pattern seed 1600 may be formed of the same material as the pattern seed 1300 of the second multilayer body 1002, or may be formed of a material different from the pattern seed 1300. The pattern seeds 1300 and 1600 are formed by selecting the optimal material in each layer. For example, by forming the pattern seed 1300 of the first layer with a conductive material containing Ti, the close-contact strength to the first insulating layer 71 and the seed layer 1200 can be improved. By forming the pattern seed 1600 of the second layer with the same conductive material (for example, only Cu) as the second inductor wiring 22, the connectivity with the vias 53 and 54 can be improved.

As illustrated in FIG. 9, the manufacturing apparatus simultaneously forms the second inductor wiring 22 and sacrificial copper 1800 on the fourth multilayer body 1004, forms the insulating layer 75 on the second inductor wiring 22, and then forms the vertical wiring 61 on the insulating layer 75 to form a fifth multilayer body 1005. The second inductor wiring 22 and the sacrificial copper 1800 are formed by, for example, a step including electric field plating (for example, electric field copper plating). The insulating layer 75 is formed by a step including insulating layer lamination, photolithography, and solidification. In this case, a magnetic path cavity 1801 and the vias 53 and 54 are simultaneously formed during the photolithography step. The vertical wiring 61 is formed by, for example, a step of sputtering (seed formation on the entire surface), laminating a resist, photolithography, electrolytic plating, resist peeling, and seed etching.

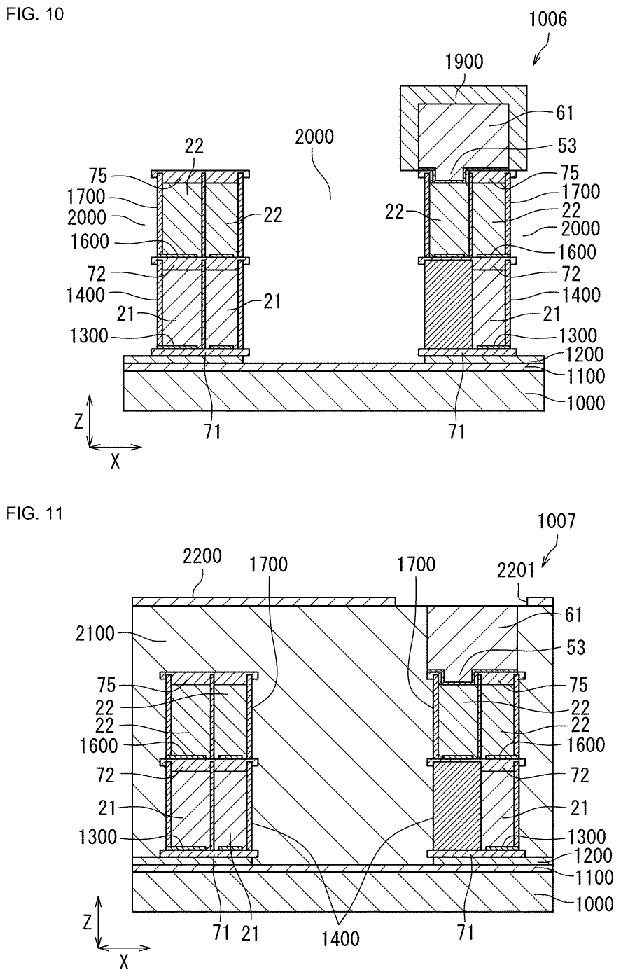

As illustrated in FIG. 10, the manufacturing apparatus forms a protective layer 1900 on the vertical wiring 61 on the fifth multilayer body 1005, removes the sacrificial copper 1500 and 1800 to form a magnetic path hole 2000, and then forms a sixth multilayer body 1006. The protective layer 1900 is formed by, for example, a step including resist lamination and photolithography. The removal of the sacrificial copper 1500 and 1800 is performed by, for example, etching. In a case in which the pattern seed 1300 of the first layer contains Ti, after Cu etching, Ti etching is performed, and a part of the seed layer 1200 remains.

As illustrated in FIG. 11, the manufacturing apparatus removes the protective layer 1900 of the sixth multilayer body 1006, forms a magnetic layer 2100, and then forms a solder resist (insulating layer) 2200 on the magnetic layer 2100 to form a seventh multilayer body 1007. The protective layer 1900 is removed by, for example, a step including resist peeling. The magnetic layer 2100 is formed by, for example, a step including magnetic material pressing, solidification, and grinding. The vertical wiring 61 is exposed to the outside by grinding. The magnetic layer 2100 forms a part of the magnetic material 201. The solder resist 2200 is formed by, for example, a step including solder resist lamination, photolithography, and solidification. A cavity 2201 through which the vertical wiring 61 is exposed to the outside is formed in the solder resist 2200. The solder resist 2200 forms the insulating layer 76.

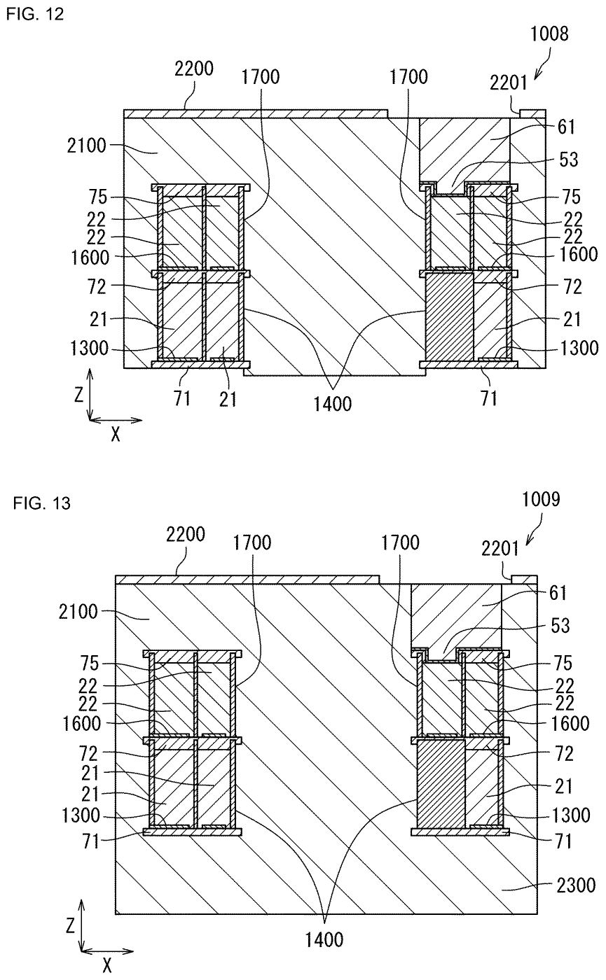

As illustrated in FIG. 12, the manufacturing apparatus removes the substrate 1000, the adhesive layer 1100, and the seed layer 1200 from the seventh multilayer body 1007 to form an eighth multilayer body 1008. The substrate 1000 and the adhesive layer 1100 are removed by, for example, mechanically peeling the adhesive layer 1100. The seed layer 1200 is removed by, for example, wet etching or polishing. In a case in which the seed layer 1200 is removed by wet etching, a part of the metal magnetic powder of the magnetic layer 2100 is etched, and a surface thereof is roughened, so that the close-contact strength with a magnetic layer 2300 formed in the next step is improved.

As illustrated in FIG. 13, the manufacturing apparatus forms the magnetic layer 2300 on the eighth multilayer body 1008 to form a ninth multilayer body 1009. The magnetic layer 2300 is formed by, for example, a step including magnetic material pressing, solidification, and grinding. Grinding is performed to adjust the thickness of the element body 2. The thickness of the element body 2 may be adjusted by adjusting an amount of pressing during the formation of the magnetic layer 2300 without performing grinding. The magnetic layer 2300 forms a part of the magnetic material 201.

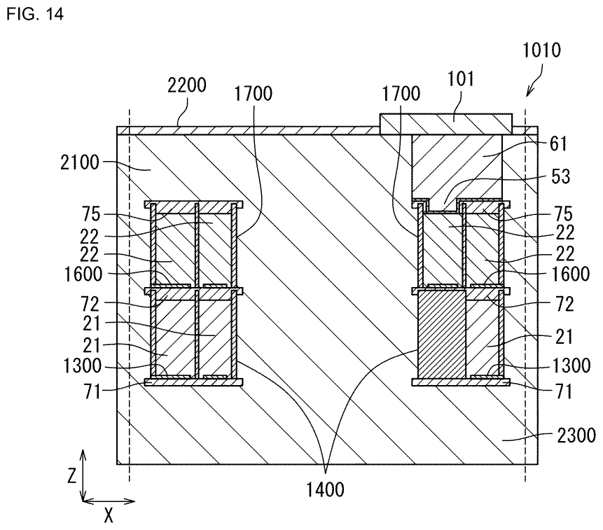

As illustrated in FIG. 14, the manufacturing apparatus forms the external terminal 101 on the ninth multilayer body 1009, forms a tenth multilayer body 1010, and then fragments the tenth multilayer body 1010 to form the inductor component 1 illustrated in FIG. 2. The external terminal 101 is formed by, for example, a step including sputtering (Cu seed), resist lamination, photolithography, electrolytic plating, resist peeling, and seed etching. The fragmentation is performed, for example, along a broken line illustrated in FIG. 14.

The exposed vertical wiring 61 may be used as the external terminal instead of forming the external terminal 101. As in the present aspect, in a case in which the configuration is adopted in which the external terminal 101 is formed in the cavity 2201 of the solder resist 2200 and is connected to the vertical wiring 61, an area of the external terminal 101 can be increased, and thus the fixation force of the inductor component 1 to another device or the like can be improved. In addition, since the external terminal 101 having any shape such as a protruding shape can be formed, the degree of freedom in a case of mounting the inductor component 1 is improved.

The external terminal 101 may be formed without forming the solder resist 2200. The external terminals 101 may be formed, for example, like the vertical wiring 61, by forming the seed layer on the entire surface and then performing electrolytic plating. In this case, the external terminal 101 has a configuration similar to a Cu bump.

The inductor component 1 can exhibit the effects described below.

The inductor component 1 includes the first conductor layer 11, the second conductor layer 12, the first inductor wiring 21, and the second inductor wiring 22. The first conductor layer 11 is located on the first virtual plane S1. The second conductor layer 12 is located on the second virtual plane S2. The first inductor wiring 21 is provided on the first conductor layer 11, is located between the first conductor layer 11 and the second conductor layer 12 in the first direction Z, and extends around the first turning axis A1. The second inductor wiring 22 is provided on the second conductor layer 12 in which the second conductor layer 12 is located between the second inductor wiring 22 and the first inductor wiring 21 in the first direction Z, and extends around the second turning axis A2. The first conductor layer 11 includes the first main body portion 111 that extends around the first turning axis A1 and the protruding portion 112 that extends from the first main body portion 111 in a direction separated from the first turning axis A1 along the second direction Y. The second conductor layer 12 includes the second main body portion 121 that extends around the second turning axis A2, and the protruding portion 122 that extends from the second main body portion 121 in a direction separated from the second turning axis A2 along the third direction X and that is located at a position not overlapping with the protruding portion 112 when viewed along the first direction Z. With this configuration, it is possible to achieve the inductor component 1 capable of improving the short-circuit resistance (interlayer short-circuit resistance) between the first inductor wiring 21 that is located on the first virtual plane S1 and the second inductor wiring 22 that is located on the second virtual plane S2 parallel and adjacent to the first virtual plane S1. In addition, since the protruding portion 112 and the protruding portion 122 are provided, the power can be supplied through the insulating layer, and thus the first inductor wiring 21 and the second inductor wiring 22 can be formed by plating growth. In the plating growth (for example, an electrolytic plating method), the first conductor layer 11 and the second conductor layer 12 having a very high purity can be formed, and thus the first inductor wiring 21 and the second inductor wiring 22 having high conductivity can be formed. As a result, the direct current electrical resistance of the inductor component 1 can be decreased. The second direction is not limited to the longitudinal direction Y, and may be the lateral direction X or a direction having components or vectors in both the lateral direction X and the longitudinal direction Y. The third direction is not limited to the lateral direction X and may be the longitudinal direction Y or a direction having components or vectors in both the lateral direction X and the longitudinal direction Y. The second direction and the third direction may be the same direction (for example, the longitudinal direction Y).

The first virtual straight line L1 and the second virtual straight line L2 form an angle of 80 degrees to 110 degrees. With this configuration, the interlayer short-circuit resistance can be more reliably improved.

The inductor component 1 includes the element body 2, the first insulating layer 71, and the second insulating layer 72. The first insulating layer 71 is provided on the first conductor layer 11 and is located on a side opposite to the first inductor wiring 21 with respect to the first conductor layer 11 in the first direction Z. The second insulating layer 72 is provided on the second conductor layer 12 and is located on a side opposite to the second inductor wiring 22 with respect to the second conductor layer 12 in the first direction Z. The protruding portion 112 is located closer to the first turning axis A1 than the end portion of the first insulating layer 71 in the second direction Y when viewed along the first direction Z. The protruding portion 122 is located closer to the second turning axis A2 than the end portion of the second insulating layer 72 in the third direction X when viewed along the first direction Z. With this configuration, since the insulation between the first inductor wiring 21 and the second inductor wiring 22 can be ensured, the degree of freedom in the design of the inductor component 1 can be improved.

The first conductor layer 11 has a thickness of smaller than 1.0 μm. The thickness of the first conductor layer 11 is smaller than 1/100 of the thickness of the first inductor wiring 21. With this configuration, the first conductor layer 11 is also sufficiently thin with respect to the first inductor wiring 21, and thus the resistance of the first inductor wiring 21 is dominant instead of the resistance of the first conductor layer 11. As a result, the selectivity of the metal material forming the first conductor layer 11 is improved. In addition, since the thickness of the first conductor layer 11 itself is sufficiently small, the interlayer short-circuit through the first conductor layer 11 can be suppressed. For example, in a case in which the first conductor layer 11 is Ti/Cu that is vapor-deposited by sputtering, Ti is formed to have a thickness of 30 nm, and Cu is formed to have a thickness of 800 nm. The first conductor layer 11 can be formed by an electroless plating method, a printing method, and the like, in addition to sputtering. For example, Au, Ag, or Al can be used as a material for the first conductor layer 11.

Each of the first conductor layer 11 and the second conductor layer 12 includes a plurality of layers laminated along the first direction Z. With this configuration, the degree of freedom in the design of the inductor component 1 can be increased, so that the cost reduction can be achieved without impairing a quality of the inductor component 1. For example, the number of layers forming each conductor layer can be optionally set depending on each layer. For example, by forming the first conductor layer 11 such that two layers (Ti/Cu) are included and the second conductor layer 12 such that two layers (Cu) are included, the close-contact strength of the first conductor layer 11 to the resin can be improved, and the close-contact strength of the second conductor layer 12 to copper (sacrificial copper) can be increased.

The inductor component 1 includes the third insulating layer 73. The third insulating layer 73 extends from the protruding portion 112 toward the second virtual plane S2 along the first direction Z, and the thickness of the third insulating layer 73 is larger than the thickness of the first inductor wiring 21. With this configuration, the insulation between a first layer including the first conductor layer 11 and the first inductor wiring 21 and a second layer including the second conductor layer 12 and the second inductor wiring 22 can be reliably ensured.

The inductor component 1 includes the external terminal 101, and the vertical wiring 61 and the fourth insulating layer 74 that are located inside the element body 2. The second inductor wiring 22, among all the inductor wirings including the first inductor wiring 21 and the second inductor wiring 22, is located closest to the external terminal 101 in the first direction Z. The vertical wiring 61 extends in the first direction Z and connects the second inductor wiring 22 and the external terminal 101 to each other in a state of being in contact with the magnetic material 201 of the element body 2 in the second direction. The fourth insulating layer 74 is located between the second inductor wiring 22 and the magnetic material 201 of the element body 2. Since the vertical wiring 61 is a wiring for connection to the external terminal 101, the insulating property can be ensured even without the insulating layer. Therefore, since the step of forming the insulating layer on the vertical wiring 61 is not necessary, the manufacturing cost of the inductor component 1 can be reduced. The vertical wiring 61 is not limited to being connected to the second inductor wiring 22 through the via 53, and may be directly connected to the second inductor wiring 22. In addition, the vertical wiring 61 may be connected to the second inductor wiring 22 through the seed layer or a layer necessary for forming the vertical wiring 61, in addition to the via 53.

A distal end portion, which is farther from the first main body portion 111, among both ends of the protruding portion 112 in the second direction is in contact with the magnetic material 201 of the element body 2. With this configuration, the corrosion of the first conductor layer 11 can be suppressed. In addition, since the protruding portion 112 is not exposed from the element body 2, the first conductor layer 11 can be isolated in the inductor component 1, and a plurality of inductor wirings that are electrically independent of each other can be disposed on the same virtual plane. As a result, it is possible to improve the degree of freedom in the design of the inductor component 1.

The inductor component 1 includes the third conductor layer 13 that is located on the first virtual plane S1 and that is electrically independent of the first conductor layer, and the third inductor wiring 23 that is provided on the third conductor layer 13. The protruding portion 112 of the first conductor layer 11 and the protruding portion 132 of the third conductor layer 13 are located on the same virtual straight lines L3 and L4. With this configuration, the inductor component 1 in which the plurality of inductor wirings that are electrically independent of each other are disposed on the same virtual plane can be achieved. The inductor component 1 can be formed as follows.

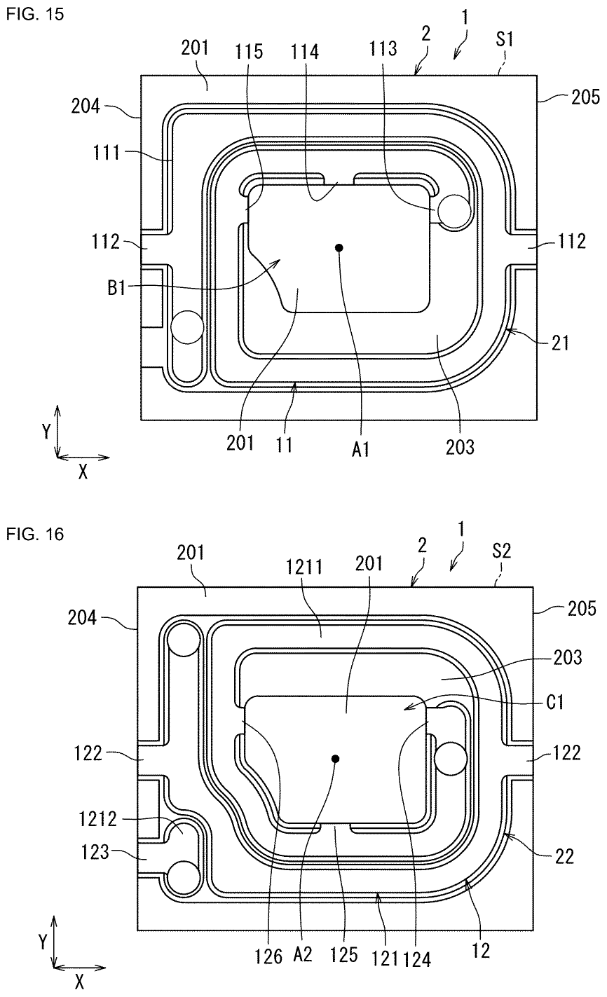

The inductor component 1 is formed such that the protruding portion 122 and the protruding portion 123 are the “second protruding portions”, or may be formed such that only the protruding portion 122 or only the protruding portion 123 is the “second protruding portion”. In the inductor component 1 including the layers illustrated in FIGS. 3 and 4, when viewed along the first direction Z, in addition to the protruding portion 122, the protruding portion 123 is also located at a position not overlapping with the protruding portion 112. In the inductor component 1 including the layers illustrated in FIGS. 15 and 16, when viewed along the first direction Z, the protruding portion 122 is located at a position overlapping with the protruding portion 112, but the protruding portion 123 is at a position not overlapping with the protruding portion 112. In the inductor component 1 including the layers illustrated in FIGS. 15 and 16, since the second conductor layer 12 includes the plurality of protruding portions 122 and 123 that are provided in a portion facing the side surface 204 of the element body 2, a plurality of the plated power supply portions can be provided on the same virtual plane S2. As a result, it is possible to improve the degree of freedom in the design of the inductor component 1. The first conductor layer 11 may include a plurality of protruding portions that are provided on a portion facing the side surface 204 of the element body 2, in addition to the second conductor layer 12 or instead of the second conductor layer 12. The side surface of the element body 2 on which the plurality of protruding portions are provided may be a side surface other than the side surface 204.

In the inductor component 1 illustrated in FIGS. 15 and 16, a distal end portion, which is farther from the first main body portion 111, among both ends of the protruding portion 112 in the third direction X is exposed from the side surfaces 204 and 205 of the element body 2 and is in contact with at least one insulating layer. The insulating layer improves the interlayer short-circuit resistance, the solder short-circuit resistance, and the corrosion resistance of the protruding portion 112. In the inductor component 1 illustrated in FIGS. 15 and 16, the distal end portions of the protruding portion 122 and the protruding portion 123 are also exposed from the side surfaces 204 and 205. The side surfaces 204 and 205 form a pair of side surfaces intersecting with the third direction X of the element body 2.

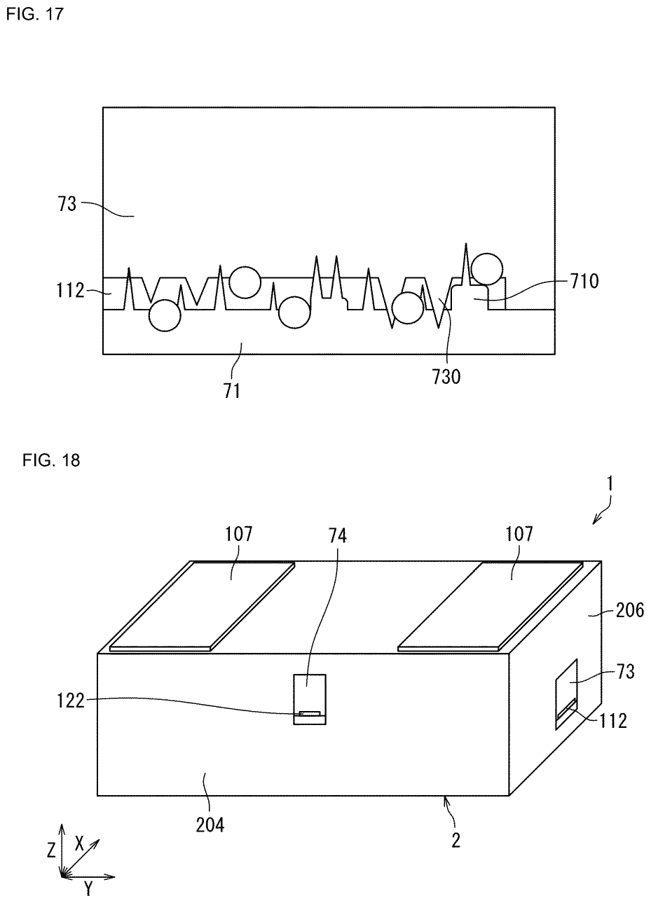

For example, during the fragmentation (see FIG. 14), by performing a down cut or an up cut (advancing while rotating a blade along the first direction Z), so that the insulating layer (for example, the first insulating layer 71 and the third insulating layer 73) located around the protruding portion 112 is stretched as illustrated in FIG. 17, and the distal end portion of the protruding portion 112 is covered. At the same time, the insulating layer (for example, the second insulating layer 72 and the fourth insulating layer 74) located around the protruding portion 122 is stretched to cover the distal end portion of the protruding portion 122. As a result, the protruding portion 112 and the protruding portion 122 of which the distal end portion is in contact with at least one insulating layer are obtained.

In FIG. 17, a stretched portion of the first insulating layer 71 is denoted by 710, and a stretched portion of the third insulating layer 73 is denoted by 730. In this way, by forming the protruding portion 112 such that the distal end portion is in contact with the plurality of insulating layers, the interlayer short-circuit resistance, the solder short-circuit resistance, and the corrosion resistance of the protruding portion 112 are more reliably improved. The distal end portion of the protruding portion 112 is covered with an insulating filler such as silica included in the first insulating layer 71 or the third insulating layer 73, so that the interlayer short-circuit resistance and the like are further improved.

The second inductor wiring 22, among all the inductor wirings including the first inductor wiring 21 and the second inductor wiring 22, is located closest to the external terminal 107 in the first direction Z. In a case in which the distal end portion of the protruding portion 122 of the second conductor layer 12 located closest to the external terminal 107 is exposed from the element body 2, there is a possibility of solder short-circuit. As illustrated in FIG. 18, by forming the inductor component 1 such that the distal end portion of the protruding portion 122 is exposed only from the side surface 204 intersecting with the third direction X among a plurality of side surfaces of the element body 2, the risk of solder short-circuit can be reduced. By exposing the distal end portion of the protruding portion 122 from the center of the side surface 204 in the second direction Y, the risk of solder short-circuit can be more reliably reduced. In the inductor component 1 illustrated in FIG. 18, the distal end portion of the protruding portion 112 is exposed only from the side surface 206 of the element body 2 extending in the third direction X. That is, in a layer of the inductor wiring other than the inductor wiring located closest to the external terminal, the distal end of the protruding portion may be exposed from a side surface other than the side surface extending in the second direction Y.

The inductor component 1 may include at least one fourth protruding portion that extends from the first main body portion 111 in a direction approaching the first turning axis A1 along the second direction, and at least one fifth protruding portion that extends from the second main body portion 121 in a direction approaching the second turning axis A2 along the third direction. The inductor component 1 illustrated in FIGS. 15 and 16 includes the three protruding portions 113, 114, and 115 as examples of a fourth protruding portion and the three protruding portions 124, 125, and 126 as examples of a fifth protruding portion. The protruding portions 113 and 115 extend along the third direction X, and the end portions, which are closer to the first turning axis A1, among both ends of the protruding portions 113 and 115 in the third direction X are in contact with the magnetic material 201 of the element body 2. The protruding portion 114 extends along the second direction Y, and the end portion, which is closer to the first turning axis A1, among both ends of the protruding portion 114 in the second direction Y is in contact with the magnetic material 201 of the element body 2. The protruding portions 124 and 126 extend along the third direction X, and the end portions, which are closer to the second turning axis A2, among both ends of the protruding portions 124 and 126 in the third direction X are in contact with the magnetic material 201 of the element body 2. The protruding portion 125 extends along the second direction Y, and the end portion, which is closer to the second turning axis A2, among both ends of the protruding portion 125 in the second direction Y is in contact with the magnetic material 201 of the element body 2. With such a configuration, the formation of the sacrificial copper is facilitated, and the magnetic path hole can be formed widely (with high accuracy), so that the volume of the magnetic material 201 that can be filled is increased, and the acquisition efficiency of the inductance of the inductor component 1 is improved. In addition, since the conductor layers can be connected to each other, the resistance during plating growth is reduced, and the variation in the plating thickness is suppressed, so that the inductor component 1 having the direct current electrical resistance as designed is obtained.

In the inductor component 1 illustrated in FIGS. 15 and 16, the number of the fourth protruding portions (that is, the protruding portions 113, 114, and 115) is equal to or larger than the number of the first protruding portions (that is, two protruding portions 112), and the number of the fifth protruding portions (that is, the protruding portions 124, 125, and 126) is equal to or larger than the number of the second protruding portions (two protruding portions 122 and protruding portion 123). Since the resistance of the conductor layer is decreased as the number of the protruding portions extending toward each turning axis is increased, the plating growth of the sacrificial copper for forming the inner magnetic path in the first regions B1 and C1 is facilitated. As a result, a layer of the next inductor wiring can be formed on a flat surface, and the variation in the first inductor wiring 21 and the second inductor wiring 22 is suppressed, so that the inductor component 1 having the direct current electrical resistance as designed can be obtained.

The inductor component 1 may include a conductor layer that is located on each of three or more virtual planes parallel to each other, and an inductor wiring that is provided on each conductor layer. That is, the inductor component 1 may include three or more layers of inductor wirings.

The inductor component 1 may be formed such that only the first conductor layer 11 is located on the first virtual plane S1, or the inductor component 1 may be formed such that three or more conductor layers including the first conductor layer 11 and the third conductor layer 13 are located. Similarly, the inductor component 1 may be formed such that only the second conductor layer 12 is located on the second virtual plane S2, or the inductor component 1 may be formed such that three or more conductor layers including the second conductor layer 12 and the fourth conductor layer 14 are located.

The angle formed by the first virtual straight line L1 and the second virtual straight line L2 is not limited to an angle of 80 degrees to 110 degrees, and may be another angle.

The insulating layer (for example, the first insulating layer 71, the second insulating layer 72, the third insulating layer 73, and the fourth insulating layer 74), the vertical wiring 61, and the vias 51, 52, 53, 54, and 55, which are located inside the element body 2, may be omitted depending on the design of the inductor component 1 and the like.

The shape and the size of each part forming the inductor component 1 are not limited to the above-described aspect, and can be optionally set depending on the design of the inductor component 1 and the like. For example, the thickness of the first conductor layer 11 of the inductor component 1 is not limited to being smaller than 1.0 μm and smaller than 1/100 of the thickness of the first inductor wiring.

Each inductor wiring need only have a spiral shape when viewed along the first direction Z. For example, each inductor wiring may be a curve having the number of turns (turn count) equal to or larger than one, or may be a curve having the number of turns of smaller than one. Each inductor wiring may have a linear shape in a part thereof.

Each inductor wiring need only have a spiral shape when viewed along the first direction Z. For example, each inductor wiring may be a curve having the number of turns (turn count) equal to or larger than one, or may be a curve having the number of turns of smaller than one. Each inductor wiring may have a linear shape in a part thereof.

In the embodiments and modification examples of the present disclosure, a combination of the embodiments, a combination of the modification examples, or a combination of the embodiments and the modification examples can be made. The features included in the embodiments and modification examples of the present disclosure can also be combined.

The details of the configuration of the present disclosure may be changed, and a combination of the elements or a change in order in each embodiment can be achieved without departing from the scope and idea of the present disclosure.

What is claimed is:

1. An inductor component comprising:
a first conductor layer that is on a first virtual plane;
a second conductor layer that is on a second virtual plane parallel and adjacent to the first virtual plane;
a first inductor wiring that is on the first conductor layer, that is between the first conductor layer and the second conductor layer in a first direction intersecting with the first virtual plane and the second virtual plane, and that extends around a first turning axis along the first direction; and
a second inductor wiring that is on the second conductor layer in which the second conductor layer is between the first inductor wiring and the second inductor wiring in the first direction, and that extends around a second turning axis along the first direction,
wherein the first conductor layer includes
a first main body portion that extends around the first turning axis, and
a first protruding portion that extends from the first main body portion in a direction away from the first turning axis along a second direction intersecting with the first direction, and
the second conductor layer includes
a second main body portion that extends around the second turning axis, and
a second protruding portion that extends from the second main body portion in a direction away from the second turning axis along a third direction intersecting with the first direction and that is at a position not overlapping with the first protruding portion when viewed along the first direction.

2. The inductor component according to claim 1, wherein
in a case in which, when viewed along the first direction, a first virtual straight line is defined as a virtual straight line connecting the first turning axis and a center of the first protruding portion in a direction intersecting with the second direction to each other, and a second virtual straight line is defined as a virtual straight line connecting the second turning axis and a center of the second protruding portion in a direction intersecting with the third direction to each other,
the first virtual straight line and the second virtual straight line defines an angle of 80 degrees to 110 degrees.

3. The inductor component according to claim 1, further comprising:
an element body which includes the first conductor layer, the second conductor layer, the first inductor wiring, and the second inductor wiring;
a first insulating layer that is on the first conductor layer and that is on a side opposite to the first inductor wiring with respect to the first conductor layer in the first direction; and
a second insulating layer that is on the second conductor layer and that is on a side opposite to the second inductor wiring with respect to the second conductor layer in the first direction,
wherein the first protruding portion is closer to the first turning axis than an end portion of the first insulating layer in the second direction when viewed along the first direction, and
the second protruding portion is closer to the second turning axis than an end portion of the second insulating layer in the third direction when viewed along the first direction.

4. The inductor component according to claim 3, wherein
the element body has a side surface intersecting with the second direction, and
the second conductor layer includes a plurality of protruding portions that are in a portion facing the side surface.

5. The inductor component according to claim 1, wherein
the first conductor layer has a thickness that is a dimension in the first direction of smaller than 1.0 μm, and
the thickness of the first conductor layer is smaller than 1/100 of the thickness of the first inductor wiring.

6. The inductor component according to claim 1, wherein
each of the first conductor layer and the second conductor layer includes a plurality of layers that are laminated along the first direction.

7. The inductor component according to claim 1, further comprising:
a third insulating layer that extends from the first protruding portion toward the second virtual plane along the first direction and that has a thickness that is a dimension in the first direction, the thickness being larger than the thickness of the first inductor wiring.

8. The inductor component according to claim 1, further comprising:
an element body that includes a magnetic material, and the first inductor wiring and the second inductor wiring are in the element body;
an external terminal that is on an outer surface of the element body intersecting with the first direction; and
a vertical wiring and a fourth insulating layer that are inside the element body,
wherein the second inductor wiring, among all inductor wirings including the first inductor wiring and the second inductor wiring, is closest to the external terminal in the first direction,
the vertical wiring extends in the first direction and connects the second inductor wiring and the external terminal to each other in a state of being in contact with the magnetic material of the element body in the second direction, and
the fourth insulating layer is between the second inductor wiring and the magnetic material of the element body.

9. The inductor component according to claim 1, further comprising:
an element body that includes a magnetic material, and the first conductor layer, the second conductor layer, the first inductor wiring, and the second inductor wiring are in the element body,
wherein a distal end portion, which is farther from the first main body portion, among both ends of the first protruding portion in the second direction is in contact with the magnetic material.

10. The inductor component according to claim 1, further comprising:
an element body, in which the first conductor layer, the second conductor layer, the first inductor wiring, and the second inductor wiring are located,
wherein the element body has a side surface intersecting with the second direction, and
a distal end portion, which is farther from the first main body portion, among both ends of the first protruding portion in the second direction is exposed from the side surface and is in contact with at least one insulating layer.

11. The inductor component according to claim 10, wherein
the distal end portion is in contact with a plurality of insulating layers.

12. The inductor component according to claim 1, further comprising:
a rectangular parallelepiped-shaped element body, in which the first conductor layer, the second conductor layer, the first inductor wiring, and the second inductor wiring are located; and
an external terminal that is on an outer surface of the element body intersecting with the first direction,
wherein the second inductor wiring, among all inductor wirings including the first inductor wiring and the second inductor wiring, is closest to the external terminal in the first direction,
the element body has a side surface intersecting with the third direction,
the side surface intersecting with the third direction includes a side surface extending in a longitudinal direction of the element body, and
a distal end portion, which is farther from the second main body portion, among both ends of the second protruding portion in the third direction is exposed only from the side surface extending in the longitudinal direction.

13. The inductor component according to claim 1, further comprising:
an element body that includes a magnetic material, and the first conductor layer, the second conductor layer, the first inductor wiring, and the second inductor wiring are in the element body;
a fourth protruding portion that is inside the element body and that extends from the first main body portion in a direction approaching the first turning axis along the second direction; and
a fifth protruding portion that is inside the element body and that extends from the second main body portion in a direction approaching the second turning axis along the third direction,
wherein an end portion, which is closer to the first turning axis, among both ends of the fourth protruding portion in the second direction is in contact with the magnetic material of the element body, and
an end portion, which is closer to the second turning axis, among both ends of the fifth protruding portion in the third direction is in contact with the magnetic material of the element body.

14. The inductor component according to claim 13, wherein
the inductor component includes a plurality of the fourth protruding portions and a plurality of the fifth protruding portions,
the number of the fourth protruding portions is equal to or larger than the number of the first protruding portions, and
the number of the fifth protruding portions is equal to or larger than the number of the second protruding portions.

15. The inductor component according to claim 1, further comprising:
a third conductor layer that is on the first virtual plane and that is electrically independent of the first conductor layer;
a third inductor wiring that is on the third conductor layer, that is located between the third conductor layer and the second conductor layer in the first direction, that extends in the first direction, and that extends around a third turning axis that is located away from the first turning axis; and
a third protruding portion that extends from the third conductor layer in a direction separated from the third turning axis along the second direction,
wherein the first protruding portion and the third protruding portion are on the same virtual straight line.

16. The inductor component according to claim 2, further comprising:
an element body which includes the first conductor layer, the second conductor layer, the first inductor wiring, and the second inductor wiring;
a first insulating layer that is on the first conductor layer and that is on a side opposite to the first inductor wiring with respect to the first conductor layer in the first direction; and
a second insulating layer that is on the second conductor layer and that is on a side opposite to the second inductor wiring with respect to the second conductor layer in the first direction,
wherein the first protruding portion is closer to the first turning axis than an end portion of the first insulating layer in the second direction when viewed along the first direction, and
the second protruding portion is closer to the second turning axis than an end portion of the second insulating layer in the third direction when viewed along the first direction.

17. The inductor component according to claim 2, wherein
the first conductor layer has a thickness that is a dimension in the first direction of smaller than 1.0 μm, and
the thickness of the first conductor layer is smaller than 1/100 of the thickness of the first inductor wiring.

18. The inductor component according to claim 2, wherein
each of the first conductor layer and the second conductor layer includes a plurality of layers that are laminated along the first direction.

19. The inductor component according to claim 2, further comprising:
a third insulating layer that extends from the first protruding portion toward the second virtual plane along the first direction and that has a thickness that is a dimension in the first direction, the thickness being larger than the thickness of the first inductor wiring.

20. The inductor component according to claim 2, further comprising:
an element body that includes a magnetic material, and the first inductor wiring and the second inductor wiring are in the element body;
an external terminal that is on an outer surface of the element body intersecting with the first direction; and
a vertical wiring and a fourth insulating layer that are inside the element body,
wherein the second inductor wiring, among all inductor wirings including the first inductor wiring and the second inductor wiring, is closest to the external terminal in the first direction,
the vertical wiring extends in the first direction and connects the second inductor wiring and the external terminal to each other in a state of being in contact with the magnetic material of the element body in the second direction, and
the fourth insulating layer is between the second inductor wiring and the magnetic material of the element body.
